(19) United States
(12) Patent Application Publication
(10) Pub. No.: US 2011/0015906 A1
(43) Pub. Date: Jan. 20, 2011

(54) METHOD AND DEVICE FOR DETERMINING A COEFFICIENT OF FRICTION

(76) Inventors: Ning Bian, Eschborn (DE); Celine Gamulescu, Regensburg (DE); Thomas Haas, Donaustauf (DE); Matthias Kretschmann, Regensburg (DE)

Correspondence Address: King & Spalding LLP, 401 Congress Avenue, Suite 3200, Austin, TX, 78701, US

(21) Appl. No.: 12/741,245

(22) PCT Filed: Nov. 7, 2008
(86) PCT No.: PCT/EP08/65145

§ 371 Date: Sep. 13, 2010

(30) Foreign Application Priority Data
Nov. 8, 2007 (DE) 102007053256.5

(51) Int. Cl. G06F 17/10; G06F 17/11

(52) U.S. Cl. 703/2; 73/9

(57) ABSTRACT

In a method for determining a coefficient of friction between a motor vehicle tire of a motor vehicle and the surface of a roadway, a first coefficient of friction parameter (μₑₛₜ_{_{—}}_{used,ij}) is determined using a model (RM) in which a functional correlation between the first coefficient of friction parameter (μₑₛₜ_{_{—}}_{used,ij}) and a slip (Sᵢⱼ) of the motor vehicle tire is set. A second coefficient of friction parameter (μ_{quasi}_{_{—}}ₘₑₐₛ_{_{—}}_{used,ij}) is determined from the quotient between a longitudinal force (FL) and a vertical force (FZ) of the motor vehicle tire. The first and the second coefficient of friction parameters (μₑₛₜ_{_{—}}_{used,ij}, μ_{quasi}_{_{—}}ₘₑₐₛ_{_{—}}_{used,ij}) are used to determine the coefficient of friction (μ_{R,ij}) by a recursive estimation algorithm.

### CROSS-REFERENCE TO RELATED APPLICATIONS

This application is a U.S. National Stage Application of International Application No. PCT/EP2008/065145 filed Nov. 7, 2008, which designates the United States of America, and claims priority to German Application No. 10 2007 053 256.5 filed Nov. 8, 2007, the contents of which are hereby incorporated by reference in their entirety.

### TECHNICAL FIELD

The invention relates to a method and a device for determining the coefficient of friction between a motor vehicle tire of a motor vehicle and the surface of a road, in particular in braking situations of the motor vehicle.

### BACKGROUND

The coefficient of friction is needed for controlling vehicle dynamics control systems and driver assist systems. Given accurate knowledge of the coefficient of friction antilock braking systems, electronic stability systems and anti-spin control systems may be controlled with particular precision. Known methods of determining the coefficient of friction between the motor vehicle and the road are based on an estimation, in which a transverse dynamic or a longitudinal dynamic of the motor vehicle is taken into account.

For determining the coefficient of friction in a braking situation it is known from EP 0 630 786 A1 to determine a braking torque from a measured brake pressure using a recursive estimation algorithm according to the least square method (recursive least square method, RLS method). For this purpose, in a wheel-selective manner the rotational speed of a wheel and the brake pressure of a motor vehicle are measured and from the rotational speed the angular acceleration of the wheel is calculated. From the angular acceleration and the brake pressure the coefficient of friction is determined by means of the recursive estimation algorithm.

From DE 195 21 544 B4 it is known to calculate the coefficient of friction from instantaneously effective actuation energies, wheel braking factors, which are determined from an axle group load distribution, and a determined height of centre of gravity of the vehicle.

For assessing a surface condition of a road, in EP 1 302 378 A2 it is provided that a linear regression coefficient and a coefficient of correlation between the slip of the front wheels and the back wheels and the acceleration and/or deceleration of the motor vehicle is determined.

### SUMMARY

According to various embodiments, a method and a device for determining the coefficient of friction between a motor vehicle tire of a motor vehicle and the surface of a road, in particular in a braking situation, can be indicated that in a simple manner enable the reliable determination of the coefficient of friction.

According to an embodiment, in a method of determining a coefficient of friction between a motor vehicle tire of a motor vehicle and the surface of a road, a first friction coefficient parameter is determined using a model, in which a functional relationship between the first friction coefficient parameter and a slip of the motor vehicle tire is defined, a second friction coefficient parameter is determined from the quotient between a longitudinal force and a contact force of the motor vehicle tire, and from the first and the second friction coefficient parameter the coefficient of friction is determined by means of a recursive estimation algorithm.

According to a further embodiment of the method, the coefficient of friction for each motor vehicle tire can be determined in accordance with the following formula:

μ_{R,ij}(k)=μ_{R}_{_{—}}_{max,ij}(k)=μ_{R,ij}(k−1)+(ARP)·(μₑₛₜ_{_{—}}_{used,ij}(k)−μ_{quasi}_{_{—}}ₘₑₐₛ_{_{—}}_{used,ij}(k))

in which
k is an arithmetic step,
ARP a defined parameter,
μ_{R,ij} a coefficient of friction,
μₑₛₜ_{_{—}}_{used,ij} the first friction coefficient parameter,
μ_{quasi}_{_{—}}ₘₑₐₛ_{_{—}}_{used,ij} the second friction coefficient parameter,
μ_{R}_{_{—}}_{max,ij} the third friction coefficient parameter.

According to a further embodiment of the method, the first friction coefficient parameter can be determined in accordance with the following formula:

μₑₛₜ_{_{—}}_{used,ij}=μ(s)=C₁·(1−e^{-C}^{₂}^{·s})−C₃·s

wherein C₁, C₂ and C₃ are parameters that are dependent upon a third friction coefficient parameter. According to a further embodiment of the method, the parameter C₁ can be determined in accordance with the following formula:

C₁=C_{1,0}·μ_{R}_{_{—}}_{max,ij},

wherein C_{1,0} is a tire-specific constant. According to a further embodiment of the method, the parameter C₂ can be determined in accordance with the following formula:

$${C}_{2} = \frac{{C}_{2 , 0}}{{μ}_{R\_max , ij}} ,$$

wherein C_{2,0} is a tire-specific constant. According to a further embodiment of the method, the parameter C₃ can be determined in accordance with the following formula:

C₃=C_{3,0}·μ_{R}_{_{—}}_{max,ij},

wherein C_{3,0} is a tire-specific constant. According to a further embodiment of the method, the third friction coefficient parameter may represent a maximum coefficient of friction between the surface of the road and the motor vehicle tire. According to a further embodiment of the method, from a longitudinal acceleration and a transverse acceleration of the motor vehicle, in particular using a dynamic wheel load model, the contact force of the motor vehicle tire can be determined. According to a further embodiment of the method, the determination of the longitudinal force of the motor vehicle tire may be effected by the determination of a brake pressure and the establishment of a torque balance at the motor vehicle tire. According to a further embodiment of the method, the determination of the longitudinal force of the motor vehicle tire may be effected by the determination of the mass of the motor vehicle and the determination of a deceleration of the motor vehicle with a defined distribution of the braking force among the motor vehicle tires.

According to another embodiment, a device for determining the coefficient of friction between a motor vehicle tire of a motor vehicle and the surface of a road, may comprise: a first means of determining a first friction coefficient parameter using a model, in which a functional relationship between the first friction coefficient parameter and a slip of the motor vehicle tire is defined, a second means of determining a second friction coefficient parameter from the quotient between a longitudinal force and a contact force of the motor vehicle tire, and a third means of determining the coefficient of friction, which is determined from the first and the second friction coefficient parameters, by means of a recursive estimation algorithm.

According to a further embodiment of the device, the device may further comprise means of implementing one of method embodiments as described above.

According to yet another embodiment, a computer program product may be loaded directly into the internal memory of a digital computer and may comprise software code sections, by means of which the steps according to one of the preceding method embodiments can be executed when the product runs on a computer.

### BRIEF DESCRIPTION OF THE DRAWINGS

There now follows a detailed description of the invention with reference to the figures. These show:

FIG. 1 a diagrammatic representation of the algorithm, on which the method according to various embodiments is based,

FIG. 2 a graph showing the coefficients of friction of various road surfaces as a function of the slip,

FIG. 3 a one-wheel model that may be used for the determination according to various embodiments of the coefficient of friction,

FIG. 4 to 6 graphs showing the coefficients of friction, determined by means of the method according to various embodiments, of various road surfaces during a braking operation as a function of time.

### DETAILED DESCRIPTION

In the method according to various embodiments for determining a coefficient of friction between a motor vehicle tire of a motor vehicle and the surface of a road a first friction coefficient parameter is determined using a model, in which a functional relationship between the first friction coefficient parameter and a slip of the motor vehicle tire is defined. A second friction coefficient parameter is further determined from the quotient between a longitudinal force and a contact force of the motor vehicle tire. From the first and the second friction coefficient parameter the coefficient of friction is determined by means of a recursive estimation algorithm.

The coefficient of friction between the motor vehicle tires of the motor vehicle and the surface of the road may be determined by means of proven and effective estimation algorithms, wherein the arithmetic outlay required for this purpose is kept within limits. In particular, the method according to various embodiments is suitable for determining the coefficient of friction in a braking situation, with due regard to the braking dynamics of the motor vehicle. A central advantage is that a determination of the coefficient of friction for each individual wheel is possible, which allows detection of a μ-split situation. In contrast to known realizations, in a calculation unit a processing, for example a comparison, of the first and second friction coefficient parameters is carried out. In this case, the first friction coefficient parameter is based on an estimated coefficient of friction, whereas the second friction coefficient parameter is quasi measured by means of the sensory acquisition and the processing of variables of the dynamics of vehicle movement.

The model used as a basis to determine the first friction coefficient parameter is based on a known relationship between the wheel slip and an actual coefficient of friction on various road coverings. Different road coverings manifest themselves in different maximum coefficients of friction, which in the framework of various embodiments are considered as third friction coefficient parameters. The modeling is effected in such a way that an initial slope of the μ-slip curve is assumed independently of the third friction coefficient parameter, while a part of the μ-slip curve with a slight slope is raised with an increasing third friction coefficient parameter and/or lowered with a decreasing third friction coefficient parameter or, from a limit value of the slip on, with increasing slip and a constant third friction coefficient parameter.

According to a further embodiment, the coefficient of friction for each motor vehicle tire is determined in accordance with the following formula:

μ_{R,ij}(k)=μ_{R}_{_{—}}_{max,ij}(k)=μ_{R,ij}(k−1)+(ARP)·(μₑₛₜ_{_{—}}_{used,ij}(k)−μ_{quasi}_{_{—}}ₘₑₐₛ_{_{—}}_{used,ij}(k)) (1)

in which
k is an arithmetic step,
ARP a defined parameter,
μ_{R,ij} a coefficient of friction,
μₑₛₜ_{_{—}}_{used,ij} the first friction coefficient parameter,
μ_{quasi}_{_{—}}ₘₑₐₛ_{_{—}}_{used,ij} the second friction coefficient parameter,
μ_{R}_{_{—}}_{max,ij} the third friction coefficient parameter.

In this equation the coefficient of friction μ_{R,ij} corresponds to the third friction coefficient parameter μ_{R}_{_{—}}_{max,ij}. The defined parameter ARP may be either a function that is dependent upon further parameters or a constant. The parameter AR is used to assess the difference between the first and the second friction coefficient parameter. The first friction coefficient parameter μₑₛₜ_{_{—}}_{used,ij} is in this case a function of the third friction coefficient parameter μ_{R}_{_{—}}_{max,ij} and/or of the coefficient of friction μ_{R,ij}. Formula (1) therefore possesses the structure of a control algorithm.

The index ij is representative of the four wheels of the motor vehicle, namely front left, front right, right rear and left rear. From this it is evident that the coefficient of friction is and/or may be determined for each individual wheel.

According to a further embodiment, the first friction coefficient parameter is determined in accordance with the following formula:

μₑₛₜ_{_{—}}_{used,ij}=μ(s)=C₁·(1−e^{-C}^{₂}^{·s})−C₃·s (2),

in which C₁, C₂ and C₃ are parameters dependent upon the third friction coefficient parameter. By means of equation (2) the functional relationship between the first friction coefficient parameter and the slip (s) of a motor vehicle tire is reproduced. In this case, the coefficient of friction μ(s) may be equated with the first friction coefficient parameter μₑₛₜ_{_{—}}_{used,ij} and used for the processing in equation (1).

The dependence of the parameters C₁, C₂ and C₃ upon the third friction coefficient parameter is as follows:

$$\begin{matrix}{C}_{1} = {C}_{1 , 0} \cdot {μ}_{R\_max , ij} , & ( 3 ) \\ {C}_{2} = \frac{{C}_{2 , 0}}{{μ}_{R\_max , ij}} , & ( 4 ) \\ {C}_{3} = {C}_{3 , 0} \cdot {μ}_{R\_max , ij} , & ( 5 )\end{matrix}$$

in which C_{1,0}, C_{2,0} and C_{3,0} are in each case tire-specific constants. μ_{R}_{_{—}}_{max,ij} represents the third friction coefficient parameter, which is a maximum coefficient of friction of the system of the road surface and the motor vehicle tire. The third friction coefficient parameter is a variable that is transmitted for each individual wheel to diverse control systems of the motor vehicle. Such control systems are for example an antilock braking system, an electronic stability system or an anti-spin control system.

For determining the second friction coefficient parameter the longitudinal force and the contact force of the motor vehicle tire are determined. The determination of the second friction coefficient parameter is effected separately for all of the motor vehicle tires of the motor vehicle.

According to an embodiment, the contact force of the motor vehicle tire is determined from a longitudinal acceleration and a transverse acceleration of the motor vehicle, in particular using a dynamic wheel load model.

The determination of the longitudinal force of the motor vehicle tire is effected according to a first variant by the determination of a brake pressure and the establishment of a torque balance at the motor vehicle tires. According to an alternative variant the determination of the longitudinal force of the motor vehicle tire is effected by the determination of the mass of the motor vehicle and the determination of a deceleration of the motor vehicle with a defined distribution of the braking force among the motor vehicle tires. In this case, the total braking force may be calculated by means of the mass and the deceleration of the vehicle. The force may be apportioned to the individual motor vehicle tires with estimated constants, for example a distribution between front and rear axle in the ratio 6:4 (wherein it is assumed that the distribution is uniform with regard to the left and right wheel on an axle), thereby allowing the longitudinal force to be calculated.

A device according to various embodiments for determining the coefficient of friction between a motor vehicle tire of a motor vehicle and the surface of a road comprises a first means of determining a first friction coefficient parameter using a model, in which a functional relationship between the first friction coefficient parameter and a slip of the motor vehicle tire is defined. The device comprises a second means of determining a second friction coefficient parameter from the quotient between a longitudinal force and a contact force of the motor vehicle tire. A third means is used to determine the coefficient of friction, which is determined from the first and the second friction coefficient parameter, by means of a recursive estimation algorithm. The same advantages as described above in connection with the method according to various embodiments are associated with this device. According to a further embodiment, the device according to various embodiments comprises further means of implementing the steps of the various methods.

According to yet a further embodiment, a computer program product may be loaded directly into the internal memory of a digital computer and may comprise software code sections, by means of which the steps according to the method according to various embodiments are executed when the program runs on a computer. The computer program product according to various embodiments may be a physical medium having stored program commands, for example a semiconductor memory, a diskette or a CD-ROM. The computer program product may also be a non-physical medium, for example a signal transmitted via a computer network.

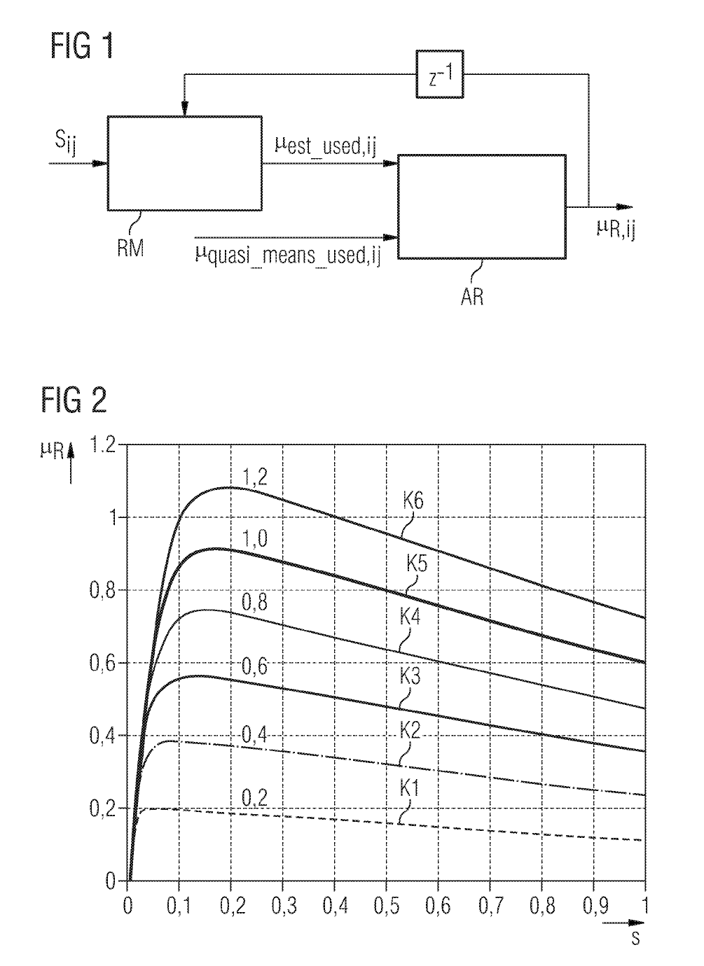

FIG. 1 shows a diagrammatic representation of the procedure underlying the various embodiments for determining a coefficient of friction between a motor vehicle tire of a motor vehicle and the surface of a road. The method according to various embodiments is implemented in a calculation unit of the motor vehicle that receives various, optionally already conditioned sensor signals of the motor vehicle. In the method a comparison is carried out between a first friction coefficient parameter μₑₛₜ_{_{—}}_{used,ij} and a second friction coefficient parameter μ_{quasi}_{_{—}}ₘₑₐₛ_{_{—}}_{used,ij}. The first friction coefficient parameter μₑₛₜ_{_{—}}_{used,ij} is determined using a tire model RM, in which a functional relationship between the first friction coefficient parameter and a slip sᵢⱼ of the motor vehicle tire is defined. The second friction coefficient parameter μ_{quasi}_{_{—}}ₘₑₐₛ_{_{—}}_{used,ij} is determined from the quotient between a longitudinal force F_{L} and a contact force F_{Z} of the motor vehicle tire.

The slip s and the second friction coefficient parameter μ_{quasi}_{_{—}}ₘₑₐₛ_{_{—}}_{used,ij}, which is a friction coefficient parameter that is determined from various sensor signals, are the input variables of a method implemented in the block AR. The first friction coefficient parameter μₑₛₜ_{_{—}}_{used,ij} is estimated from the slip and the determined coefficient of friction μ_{R,ij} by means of the tire model RM, which is explained in detail later. μR,ij is an output variable of the block AR and represents the coefficient of friction to be determined, which is fed back to the tire model RM for adaption of the first friction coefficient parameter (cf. block z⁻¹).

The first and the second friction coefficient parameters μₑₛₜ_{_{—}}_{used,ij} and μquasi_{_{—}}ₘₑₐₛ_{_{—}}_{used,ij} are supplied to the block AR as input variables for an adaptive control. This adaptive control in the block AR is based on the formula:

μ_{R,ij}(k)=μ_{R}_{_{—}}_{max,ij}(k)=μ_{R,ij}(k−1)+(ARP)·(μₑₛₜ_{_{—}}_{used,ij}(k)−μ_{quasi}_{_{—}}ₘₑₐₛ_{_{—}}_{used,ij}(k)) (1),

in which k is an arithmetic step, ARP a defined parameter (a constant or a function that is dependent upon further parameters), μₑₛₜ_{_{—}}_{used,ij} the first friction coefficient parameter, and μ_{quasi}_{_{—}}ₘₑₐₛ_{_{—}}_{used,ij} the second parameter. Equation (1) has the structure of a control algorithm. The determination of the coefficient of friction is effected separately for all of the motor vehicle tires of the motor vehicle, this being indicated by the index ij. Preferably all four wheels of the motor vehicle, namely front left, front right, rear left and rear right, are taken into consideration. As may be seen clearly from equation (1), the actual coefficient of friction μ_{R,ij} (k) is equal to the coefficient of friction of the preceding step μ_{R,ij}(k−1) plus the multiplication of the parameter ARP by the difference between the first and the second friction coefficient parameter. An advantage of the determination of the coefficient of friction in accordance with the above method is that in a simple manner a determination of the coefficient of friction of each individual wheel is possible, which allows detection of a μ-split situation.

The parametrization of the tire model RM is carried out by means of the coefficient of friction μ_{R,ij} in such a way that the initial slope of a μ-slip curve is assumed independently of the coefficient of friction μ_{R,ij}, while a part of the μ-slip curve with a slight slope is raised with increasing μ_{R,ij} and/or lowered with decreasing μ_{R,ij} or [see translator's note] however a limit value of the slip with increasing slip and constant μ_{R,ij}. The tire model therefore corresponds to the known relationship between wheel slip and actual coefficient of friction.

For the functional relationship between the coefficient of friction μ and the slip s it is possible to use the formula:

μₑₛₜ_{_{—}}_{used,ij}=μ(s)=C₁·(1−e^{-C}^{₂}^{·s})−C₃−s (2).

The slip-dependent coefficient of friction u(s) corresponds to the first friction coefficient parameter μₑₛₜ_{_{—}}_{used,ij} and is used in equation (1) in the control algorithm described there. The dependence of the parameters C₁, C₂ and C₃ in equation (2) upon the friction coefficient parameter is selected as follows:

$$\begin{matrix}{C}_{1} = {C}_{1 , 0} \cdot {μ}_{R\_max , ij} , & ( 3 ) \\ {C}_{2} = \frac{{C}_{2 , 0}}{{μ}_{R\_max , ij}} , & ( 4 ) \\ {C}_{3} = {C}_{3 , 0} \cdot {μ}_{R\_max , ij} , & ( 5 )\end{matrix}$$

wherein C_{1,0}, C_{2,0} and C_{3,0} are tire-specific constants and μ_{R}_{_{—}}_{max,ij} is the maximum coefficient of friction between the surface of the road and the motor vehicle tire. In practice, μ_{R}_{_{—}}_{max,ij} is a variable that is transmitted for each individual wheel for processing purposes to the control systems present in the motor vehicle. Such control systems may be an antilock braking system, an electronic stability system and the like.

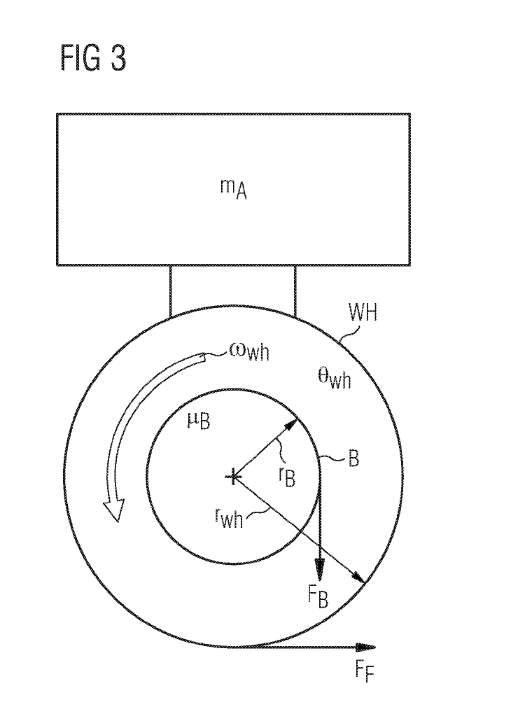

FIG. 2 shows measurements of the coefficient of friction μ_{R} as a function of the wheel slip s for various road surfaces, which are known from the literature. For each of the curves K1, K2, K3, K4, K5, K6 a respective third friction coefficient parameter μ_{R}_{_{—}}_{max,ij} is represented, which corresponds to an associated road covering. The third friction coefficient parameter μ_{R max,ij} for curve K1 is 0.2, wherein the road surface is covered for example with snow. In a corresponding manner, the third friction coefficient parameter μ_{R}_{_{—}}_{max,ij} for the curve K2 is 0.4 etc. All of the curves K1 to K6 represented in FIG. 2 begin at the point μ=0 for s=0 and then rise to their respective maximum, which lies at a wheel slip of ca. s=0.005 to 0.25. The coefficient of friction μ then decreases, wherein a transition occurs from the static friction essential for load transmission to sliding friction.

The wheel slip required in the tire model RM may be determined by means of the following equation:

$${s}_{ij} = \frac{{v}_{vehicle} - {v}_{wh , ij}}{{v}_{vehicle}} , \qquad ( 6 )$$

wherein v_{vehicle} is the vehicle velocity (which is transformed to the positions and in the direction of the wheels in the case of a not negligible transverse dynamic) and v_{wh,ij} is the rotatory wheel velocity of a motor vehicle. The rotatory wheel velocity v_{wh,ij} may be calculated from the wheel rotational speed and the running radius. The determination is effected preferably for all wheels ij of the motor vehicle.

From the now existing information the first friction coefficient parameter μₑₛₜ_{_{—}}_{used,ij} may be determined by means of the tire model RM with the aid of the slip s and the actually determined third friction coefficient parameter μ_{R}_{_{—}}_{max,ij}. For the determination of the second friction coefficient parameter μ_{quasi}_{_{—}}ₘₑₐₛ_{_{—}}_{used,ij} it is necessary to determine the longitudinal- and wheel contact forces F_{L} and F_{Z}. The second friction coefficient parameter is determined in accordance with the following equation:

$${μ}_{quasi\_meas \_used} = \frac{{F}_{L}}{{F}_{Z}} , \qquad ( 7 )$$

wherein this equation is considered for only one wheel. The dependence of the second friction coefficient parameter μquasi_{_{—}}ₘₑₐₛ_{_{—}}_{used,ij} has been suppressed in this case.

The wheel contact force F_{Z} may be estimated by means of a known dynamic wheel load model, simultaneously taking into account a longitudinal- and a transverse acceleration of the motor vehicle. The determination of the wheel contact force F_{Z} is prior art and is therefore not described in detail at this point.

For determining the longitudinal force F_{L} of the motor vehicle several, likewise known approaches exist.

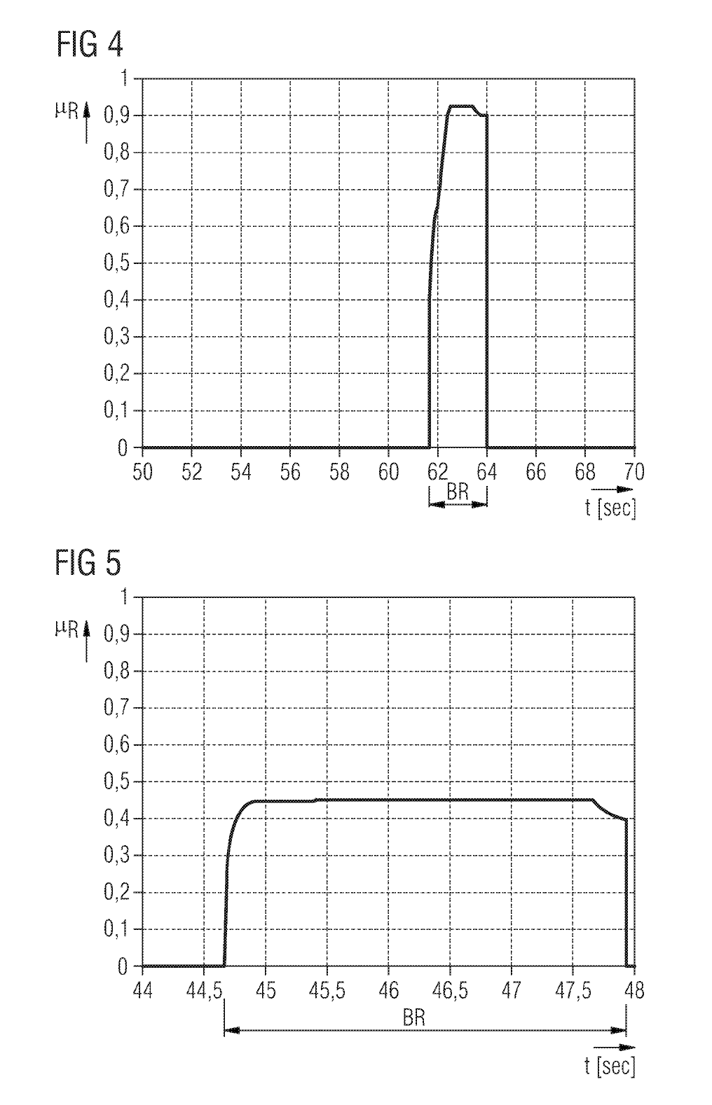

For example, calculation of the longitudinal force FL is possible using a brake pressure that is determined by sensor. This is described in detail below with reference to FIG. 3. FIG. 3 shows a so-called one-wheel or quarter vehicle model. Here, only the conditions at one motor vehicle tire of the motor vehicle are considered. The “quarter vehicle” has a mass m_{A}, a motor vehicle tire WH and a brake disk B. F_{B} is a braking force between a brake lining and the brake disk B and F_{F} is the friction force between the motor vehicle tire and the road surface. r_{wh} represents the radius of the motor vehicle tire, r_{B} the effective radius for the build-up of the braking force. μ_{B} is the coefficient of friction between the brake disk and the brake lining Θ_{wh} is the moment of inertia of the motor vehicle tire. ω_{wh} is the angular velocity of the motor vehicle tire.

The relationship between the braking torque and the friction torque may be derived by means of a torque balance at the motor vehicle tire:

M_{F}(t)=M_{B}−Δω_{wh}(k)·θ_{wh} (8).

Here,

$${Δω}_{wh} ( k ) = \frac{{ω}_{wh} ( k ) - {ω}_{wh} ( k - 1 )}{Δ T} \qquad ( 9 )$$

represents the time derivative of the wheel angular velocity and ΔT a scanning time. The braking torque may be calculated by multiplication of the braking force F_{B} and the effective radius r_{B} in accordance with formula (10):

M_{B}(t)=F_{B}(t)·r_{B} (10),

wherein

F_{B}(t)=μ_{B}(t)·p_{B}(t)·s_{B} (11).

Here, p_{B} represents the brake pressure and s_{B} the corresponding effective area during the braking operation.

The friction torque may be calculated by multiplication of the friction force F_{F} and the effective wheel radius r_{wh}:

M_{F}(t)=F_{F}(t)·r_{wh} (12),

wherein

F_{F}(t)=μ(s)·F_{z} (13).

The slip-dependent coefficient of friction μ(s) corresponds to the actual coefficient of friction between the vehicle wheel and the road surface. F_{Z} represents the wheel contact force. This, in combination with equation (7), produces:

$${μ}_{quasi\_meas \_used} = μ = \frac{{μ}_{B} ( t ) \cdot {p}_{B} ( t ) \cdot {s}_{B} \cdot {r}_{B} - \frac{{ω}_{wh} ( k ) - ω ( k - 1 )}{T} \cdot {θ}_{wh}}{{F}_{Z} \cdot {r}_{wh}} , \qquad ( 14 )$$

with which the second friction coefficient parameter μ_{quasi}_{_{—}}ₘₑₐₛ_{_{—}}_{used} for a motor vehicle tire is determined.

Alternatively, the determination of the second friction coefficient parameter μ_{quasi}_{_{—}}ₘₑₐₛ_{_{—}}_{used,ij} may be determined in that the longitudinal force occurs as a result of the deceleration of the vehicle with an estimated constant distribution among all of the wheels. In this case, the total braking force may be calculated by means of the mass and the deceleration of the vehicle. This force is then distributed among the four wheels. For the distribution between front and rear axle a ratio of 6:4 for example may be selected, wherein it is assumed that a uniform distribution to the left and right wheel of a respective axle occurs. By said means the longitudinal force is calculated. By inserting into formula (7) it is then possible in turn to determine the second friction coefficient parameter μ_{quasi}_{_{—}}ₘₑₐₛ_{_{—}}_{used} for a motor vehicle tire.

The determination of the wheel contact force by means of a rigid wheel load model or by using a state observer with or without parameter adaption is known in principle. The exact procedure may be gathered for example from the thesis of Sven Kraus, “Development and Analysis of Linear and Non-linear State Observers for Estimating the Coefficient of Friction between Tire and Road”, 2 Nov. 2005, Chair of Automotive Engineering, TU Munich, in chapter 4.2.1 and/or 4.2.2. Reference is made to this in the present description.

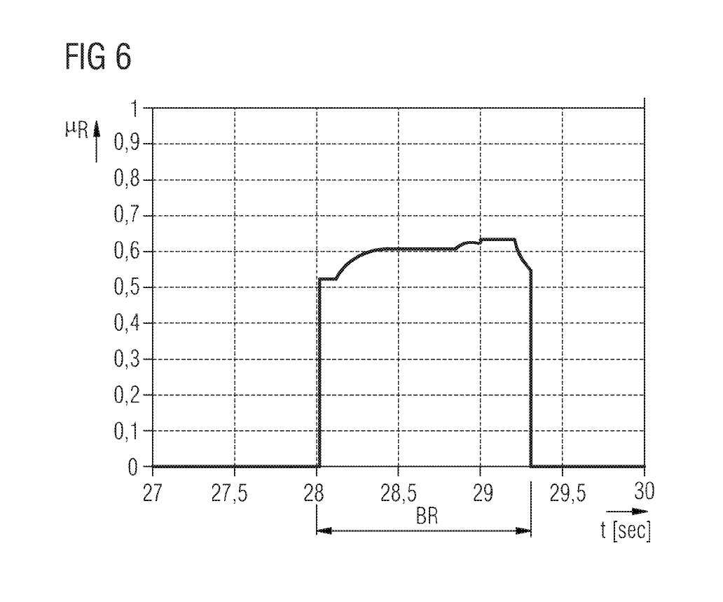

FIGS. 4 to 6 show in each case a graph representing the coefficients of friction μ_{R}, estimated by means of the method according to various embodiments, as a function of time t. FIG. 4 represents an estimation of the coefficient of friction on asphalt, wherein in the time interval denoted by BR a braking operation occurs. Outside of the interval denoted by BR the motor vehicle moves normally, i.e. is not braked. The coefficient of friction rises to ca. 0.9 with the beginning of the braking operation at time t≈62 sec and drops back to 0 upon termination of the braking operation at time t≈64 sec. In a corresponding manner FIG. 5 shows the estimation of the coefficient of friction on rough ice, wherein in the time interval denoted by BR a braking operation occurs. The coefficient of friction rises from 0 to ca. 0.4 upon the change from normal travel to a braking operation at time t=44.7 sec. Upon termination of the braking phase at time t=48 sec, the coefficient of friction decreases back to 0. FIG. 6 shows the estimation of the coefficient of friction on wet asphalt, wherein once more during the time interval BR a braking operation occurs. In this case, with the beginning of the braking operation a rise of the coefficient of friction to 0.5 to 0.6 may be seen. The coefficient of friction drops back down to 0 as soon as the braking operation (t=29.3 sec) is terminated.

The method according to various embodiments allows a reliable estimation of the coefficient of friction between a motor vehicle tire of a motor vehicle and the surface of a road. The method further has the advantage that the convergence of the coefficient-of-friction detection is speeded up. This improves the ruggedness of the coefficient-of-friction estimator. In this case, an estimation of the coefficient of friction for each individual wheel may be carried out.

What is claimed is:

1. A method of determining a coefficient of friction between a motor vehicle tire of a motor vehicle and the surface of a road, comprising the steps of
Determining a first friction coefficient parameter using a model, in which a functional relationship between the first friction coefficient parameter and a slip of the motor vehicle tire is defined,
Determining a second friction coefficient parameter from the quotient between a longitudinal force and a contact force of the motor vehicle tire, and
Determining from the first and the second friction coefficient parameter the coefficient of friction by means of a recursive estimation algorithm.

2. The method according to claim 1, wherein the coefficient of friction for each motor vehicle tire is determined in accordance with the following formula:
μ_{R,ij}(k)=μ_{R}_{_{—}}_{max,ij}(k)=μ_{R,ij}(k−1)+(ARP)·(μₑₛₜ_{_{—}}_{used,ij}(k)−μ_{quasi}_{_{—}}ₘₑₐₛ_{_{—}}_{used,ij}(k))
in which
k is an arithmetic step,
ARP a defined parameter,
μ_{R,ij} a coefficient of friction,
μₑₛₜ_{_{—}}_{used,ij} the first friction coefficient parameter,
μ_{quasi}_{_{—}}ₘₑₐₛ_{_{—}}_{used,ij} the second friction coefficient parameter,
μ_{R}_{_{—}}_{max,ij} the third friction coefficient parameter.

3. The method according to claim 1, wherein the first friction coefficient parameter is determined in accordance with the following formula:
μₑₛₜ_{_{—}}_{used,ij}=μ(s)=C₁·(1−e^{-C}^{₂}^{·s})−C₃·s
wherein C₁, C₂ and C₃ are parameters that are dependent upon a third friction coefficient parameter.

4. The method according to claim 3, wherein the parameter C₁ is determined in accordance with the following formula:
C₁=C_{1,0}·μ_{R}_{_{—}}_{max,ij},
wherein C_{1,0} is a tire-specific constant.

5. The method according to claim 3, wherein the parameter C₂ is determined in accordance with the following formula:
$${C}_{2} = \frac{{C}_{2 , 0}}{{μ}_{R\_max , ij}} ,$$
wherein C_{2,0} is a tire-specific constant.

6. The method according to claim 3, wherein the parameter C₃ is determined in accordance with the following formula:
C₃=C_{3,0}·μ_{R}_{_{—}}_{max,ij},
wherein C_{3,0} is a tire-specific constant.

7. The method according to claim 4, wherein the third friction coefficient parameter represents a maximum coefficient of friction between the surface of the road and the motor vehicle tire.

8. The method according to claim 1, wherein from a longitudinal acceleration and a transverse acceleration of the motor vehicle, using a dynamic wheel load model, the contact force of the motor vehicle tire is determined.

9. The method according to claim 1, wherein the determination of the longitudinal force of the motor vehicle tire is effected by the determination of a brake pressure and the establishment of a torque balance at the motor vehicle tire.

10. The method according to claim 1, wherein the determination of the longitudinal force of the motor vehicle tire is effected by the determination of the mass of the motor vehicle and the determination of a deceleration of the motor vehicle with a defined distribution of the braking force among the motor vehicle tires.

11. A device for determining the coefficient of friction between a motor vehicle tire of a motor vehicle and the surface of a road, comprising
a first means of determining a first friction coefficient parameter using a model, in which a functional relationship between the first friction coefficient parameter and a slip of the motor vehicle tire is defined,
a second means of determining a second friction coefficient parameter from the quotient between a longitudinal force and a contact force of the motor vehicle tire, and
a third means of determining the coefficient of friction, which is determined from the first and the second friction coefficient parameters, by means of a recursive estimation algorithm.

12. The device according to claim 11, further comprising means for determining the coefficient of friction for each motor vehicle tire in accordance with the following formula:
μ_{R,ij}(k)=μ_{R}_{_{—}}_{max,ij}(k)=μ_{R,ij}(k−1)+(ARP)·(μₑₛₜ_{_{—}}_{used,ij}(k)−μ_{quasi}_{_{—}}ₘₑₐₛ_{_{—}}_{used,ij}(k))
in which
k is an arithmetic step,
ARP a defined parameter,
μ_{R,ij} a coefficient of friction,
μₑₛₜ_{_{—}}_{used,ij} the first friction coefficient parameter,
μ_{quasi}_{_{—}}ₘₑₐₛ_{_{—}}_{used,ij} the second friction coefficient parameter,
μ_{R}_{_{—}}_{max,ij} the third friction coefficient parameter.

13. The device according to claim 11, further comprising means for determining the first friction coefficient parameter in accordance with the following formula:
μₑₛₜ_{_{—}}_{used,ij}=μ(s)=C₁·(1−e^{-C}^{₂}^{·s})−C₃·s
wherein C₁, C₂ and C₃ are parameters that are dependent upon a third friction coefficient parameter.

14. The device according to claim 13, further comprising means for determining the parameter C₁ in accordance with the following formula:
C₁=C_{1,0}·μ_{R}_{_{—}}_{max,ij},
wherein C_{1,0} is a tire-specific constant.

15. The device according to claim 13, further comprising means for determining the parameter C₂ in accordance with the following formula:
$${C}_{2} = \frac{{C}_{2 , 0}}{{μ}_{R\_max , ij}} ,$$
wherein C_{2,0} is a tire-specific constant.

16. The device according to claim 13, further comprising means for determining the parameter C₃ in accordance with the following formula:
C₃=C_{3,0}·μ_{R}_{_{—}}_{max,ij},
wherein C_{3,0} is a tire-specific constant.

17. The device according to claim 14, wherein the third friction coefficient parameter represents a maximum coefficient of friction between the surface of the road and the motor vehicle tire.

18. The device according to claim 11, wherein from a longitudinal acceleration and a transverse acceleration of the motor vehicle, the contact force of the motor vehicle tire is determined.

19. The device according to claim 11, wherein the determination of the longitudinal force of the motor vehicle tire is effected by the determination of a brake pressure and the establishment of a torque balance at the motor vehicle tire.

20. The method according to claim 1, wherein the determination of the longitudinal force of the motor vehicle tire is effected by the determination of the mass of the motor vehicle and the determination of a deceleration of the motor vehicle with a defined distribution of the braking force among the motor vehicle tires.

21. A computer program product comprising computer readable instruction which when loaded into an internal memory of a digital computer and executed perform the steps:
Determining a first friction coefficient parameter using a model, in which a functional relationship between the first friction coefficient parameter and a slip of a motor vehicle tire is defined,
Determining a second friction coefficient parameter from the quotient between a longitudinal force and a contact force of the motor vehicle tire, and
Determining from the first and the second friction coefficient parameter the coefficient of friction by means of a recursive estimation algorithm.
